(19) United States
(12) Patent Application Publication
(10) Pub. No.: US 2006/0265887 A1
(43) Pub. Date: Nov. 30, 2006

(54) Apparatus and Method for Extending the Useful Life of a Cutting Edge Tool

(76) Inventor: Randy S. Malkewich, Calgary, AB (CA)

Correspondence Address: WILLIAM J BUNDREN;THE LAW OFFICE OF WILLIAM J BUNDREN, 734 LaRue Road, Millersville, MD, 21108, US

(21) Appl. No.: 11/421,124

(22) Filed: May 31, 2006

(30) Foreign Application Priority Data
May 31, 2005 (CA) 2508643

(51) Int. Cl. B26B 21/40

(52) U.S. Cl. 30/541; 30/298.4

(57) ABSTRACT

An apparatus and method for supporting and extending the useful life of the cutting edge of a cutting edge tool is provided. The apparatus comprises a housing for supporting a cutting edge tool such as a shaving razor. Disposed within the housing is a metal member that is positioned underneath the cutting edge of the tool. The metal member comprises a plurality of upward facing protrusions configured in a grid pattern. An additional metal layer is disposed within the housing between the metal member and the cutting edge tool. The method comprises providing a housing containing the metal member and then placing a cutting edge tool on the housing such that the cutting edge is positioned above the metal member. It is observed that placing a cutting edge tool on the apparatus after using the tool extends the useful life of the cutting edge tool.

### FIELD OF THE INVENTION

The present invention relates to the field of apparatuses and methods for extending the useful life of cutting edges of cutting edge tools.

### BACKGROUND OF THE INVENTION

Cutting edge tools lose their sharpness as a result of a number of factors including the use of the tool. In many applications, a sharp cutting edge is desirable and safer to use. Examples of cutting edge tools and their applications include, without limitation, a razor blade for shaving, a knife for cutting food, scissors for cutting hair, paper or fabric, knife blades for cutting tools and cutting shears. For cutting tools exposed to moisture during their use, corrosion can occur on the cutting edge and shorten the useful life of the cutting edge.

It is, therefore, desirable to extend the useful life of a cutting edge of a cutting edge tool.

### SUMMARY OF THE INVENTION

An apparatus and method for supporting a cutting edge tool and for extending the useful life of a cutting edge of a cutting edge tool is provided. The apparatus consists of a metal member, such as copper, mounted in a housing adapted to receive the metal member and to support a cutting edge tool. The metal member can have a number of upward facing protrusions embossed or formed on the face of the metal member. In one embodiment, these protrusions are pyramid-shaped.

In one embodiment of the apparatus, the housing is adapted to support a cutting edge tool such as a shaving razor. The metal member is situated or disposed within the housing such that when the shaving razor is supported by the housing, the metal cutting edges of the shaving razor are facing downwards and the metal member is positioned beneath the cutting edges such that the pyramid-shaped protrusions of the metal member are facing upwards toward the cutting edge. When a shaving razor is supported by the housing, the cutting edges of the shaving razor are suspended above the upward facing protrusions of the metal member by a distance in the range of about 1 millimetre to 10 millimetres. In another embodiment of the apparatus, a second layer of metal, such as copper, is disposed within the housing such that it is situated between the upward facing protrusions and the cutting edge of the shaving razor. In yet another embodiment, the housing encloses the metal member and the metal layer. The housing can be made of a non-metallic material such as plastic or any other suitable material as known by those skilled in the art. In other embodiments, the housing of the apparatus can be adapted to support other cutting edge tools such as knife blades, scissors, knives and cutting shears in addition to shaving razors.

A method of extending the useful life of a cutting edge tool consists of placing the cutting edge tool on top of the housing described above after the cutting edge tool has been used such that the cutting edge is suspended above the upward facing protrusions of the metal member. It is observed that placing a cutting edge tool, such as a shaving razor, on top of the housing described above after being used can extend the useful life of the cutting edges of the cutting edge tool.

Broadly stated, one aspect of an apparatus for extending the useful life of a cutting edge of a cutting edge tool, comprises a member made of metal having a plurality of upward facing protrusions; and a housing adaptive for receiving said metal member, said housing adapted for supporting a cutting edge tool having a cutting edge whereby said cutting edge is suspended above said protrusions when said cutting edge tool is supported by said housing.

Broadly stated, one aspect of a method for extending the useful life of a cutting edge of a cutting edge tool comprises the steps of providing an apparatus comprising a member made of metal having a plurality of upward facing protrusions and a housing adapted for receiving said member, said housing adapted for supporting said cutting edge tool having a cutting edge whereby said cutting edge is suspended above said protrusions when said cutting edge tool is supported by said housing; and placing said cutting edge tool onto said housing whereby said cutting edge tool is supported by said housing and said cutting edge is suspended above said protrusions.

Broadly stated, one aspect of an apparatus for supporting a cutting edge tool comprises a member made of metal having a plurality of upward facing protrusions; and a housing adapted for receiving said metal member, said housing adapted for supporting a cutting edge tool having a cutting edge whereby said cutting edge is suspended above said protrusions when said cutting edge tool is supported by said housing.

### BRIEF DESCRIPTION OF THE DRAWINGS

FIG. 1 is a perspective view depicting a metal member that is disposed within an apparatus for supporting a cutting edge tool.

FIG. 2 is a cross-sectional elevational side view depicting an apparatus for supporting a shaving razor.

FIG. 3 is a perspective view depicting the apparatus of FIG. 2.

### DETAILED DESCRIPTION OF EMBODIMENTS

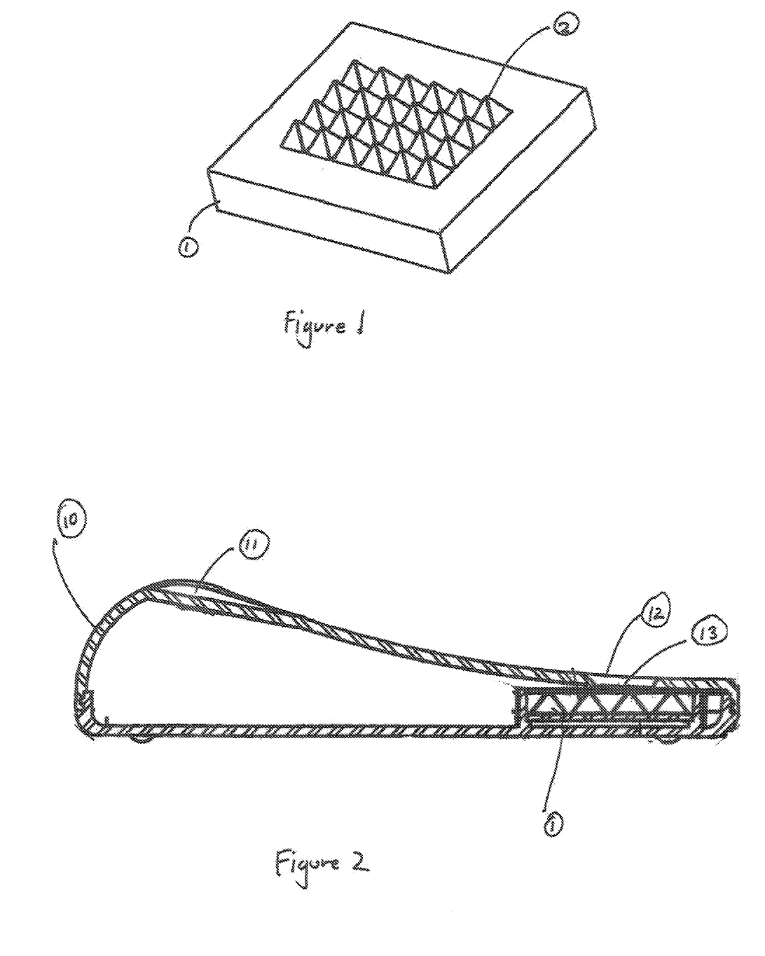

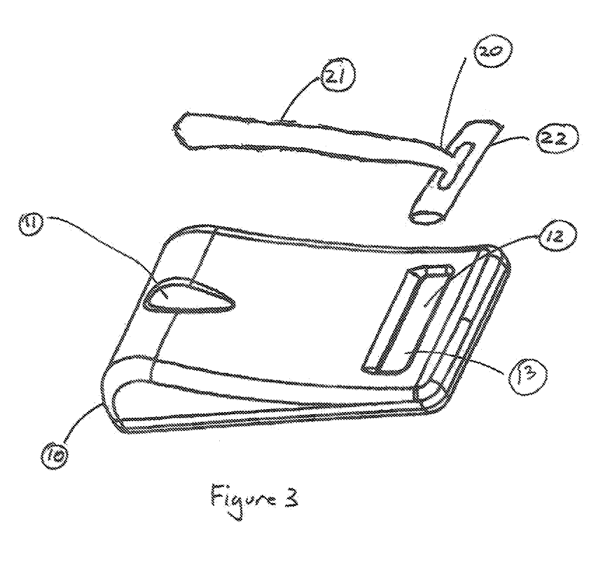

An apparatus for supporting a cutting edge tool and for extending the useful life of a cutting edge tool is shown in FIGS. 1 and 2. Metal member 1 is shown in FIG. 1. On the upper surface of metal member 1 is a plurality of upward facing pyramids 2. Pyramids 2 can be configured in a rectangular grid pattern. In one embodiment of the apparatus, pyramids 2 are configured in a grid of 4 by 6 pyramids for a total of 24 although other grid configurations can be used.

Shown in FIG. 2 is a cross-sectional view of razor holder 10, comprising cradle 11, razor head receptacle 12 and metal member 1 and metal layer 13.

Shown in FIG. 3 is razor holder 10. Razor holder 10 comprises cradle 111 for supporting the razor handle 21 of razor 20 and razor head receptacle 12 for receiving razor head 22 of razor 20. In this embodiment, metal member 1 would lie (not shown in FIG. 3) under razor head receptacle 12 and metal layer 13. In one embodiment of the apparatus, metal member 1 and metal layer 13 are made of a nonferrous metal. In an another embodiment, metal member 1 and metal layer 13 are made of copper or of a copper alloy such as bronze.

In operation when razor 20 is set into razor holder 10, razor handle 21 would be placed in cradle 11 and razor head 22 would be set into razor head receptacle 12. It is observed that after razor 20 has been used for shaving and then placed onto razor holder 10, the useful life of razor 20 is extended. In other words, it is observed that razor 20 can be used for more shaves than originally intended by the manufacturer of razor 20. The inventor believes that setting razor 20 on razor holder 10 assists in the draining of water off of the razor blade(s) of razor 20 which may, in part, extend the useful life of razor 20. The inventor, however, does not wish to be limited to this theory of operation as, for example, forces of nature may be at work in extending the useful life of razor 20 when it is placed on razor holder 10.

Although some embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the scope of the invention is defined and limited only by the claims that follow.

1. An apparatus for extending the useful life of a cutting edge of a cutting edge tool, comprising:
a) a member made of metal having a plurality of upward facing protrusions; and
b) a housing adaptive for receiving said metal member, said housing adapted for supporting a cutting edge tool having a cutting edge whereby said cutting edge is suspended above said protrusions when said cutting edge tool is supported by said housing.

2. The apparatus as set forth in claim 1 whereby said cutting edge tool is selected from the group consisting of shaving razors, knife blades, scissors, knives and cutting shears.

3. The apparatus as set forth in claim 1 whereby said member is made of a non-ferrous metal.

4. The apparatus as set forth in claim 3 whereby said non-ferrous metal is copper.

5. The apparatus as set forth in claim 3 whereby said non-ferrous metal is a copper alloy.

6. The apparatus as set forth in claim 1 wherein said cutting edge is suspended above said protrusions via distance in the range of about 1 millimetre to 10 millimetres.

7. The apparatus as set forth in claim 1 wherein said protrusions are pyramid shaped.

8. The apparatus as set forth in claim 1 wherein said housing further comprises a layer of metal disposed between said protrusions and said cutting edge when said cutting edge tool is supported by said housing.

9. The apparatus as set forth in claim 8 wherein said layer of metal is made of a non-ferrous metal.

10. The apparatus as set forth in claim 9 wherein said non-ferrous metal is copper.

11. The apparatus as set forth in claim 9 wherein said non-ferrous metal is a copper alloy.

12. A method for extending the useable life of a cutting edge of a cutting edge tool, the method comprising the steps of:
a) providing an apparatus comprising:
i) a member made of metal having a plurality of upward facing protrusions, and
ii) a housing adapted for receiving said member said housing adapted for supporting said cutting edge tool having a cutting edge whereby said cutting edge is suspended above said protrusions when said cutting edge tool is supported by said housing; and
b) placing said cutting edge tool onto said housing whereby said cutting edge tool is supported by said housing and said cutting edge is suspended above said protrusions.

13. The method as set forth in claim 12 wherein said cutting edge tool is selected from the group consisting of shaving razors, knife blades, scissors, knives and cutting shears.

14. The method as set forth in claim 12 wherein said member is made of a non-ferrous metal.

15. The method as set forth in claim 14 wherein said non-ferrous metal is copper.

16. The method as set forth in claim 14 wherein said non-ferrous metal is a copper alloy.

17. The method as set forth in claim 12 wherein said cutting edge is suspended above said protrusions by distance in the range of about 1 millimetre to 10 millimetres.

18. The method as set forth in claim 12 wherein said protrusions are pyramid-shaped.

19. The method as set forth in claim 12 wherein said housing further comprises a layer of metal disposed between said protrusions and said cutting edge when said cutting edge tool is supported by said housing.

20. The method as set forth in claim 19 wherein said layer of metal is made of a non-ferrous metal.

21. The method as set forth in claim 20 wherein said non-ferrous metal is copper.

22. The method as set forth in claim 20 wherein said non-ferrous metal is a copper alloy.

23. An apparatus for supporting a cutting edge tool, comprising.
a) a member made of metal having a plurality of upward facing protrusions; and
b) a housing adapted for receiving said metal member, said housing adapted for supporting a cutting edge tool having a cutting edge whereby said cutting edge is suspended above said protrusions when said cutting edge tool is supported by said housing.

24. The apparatus as set forth in claim 23 whereby said cutting edge tool is selected from the group consisting of shaving razors, knife blades, scissors, knives and cutting shears.

25. The apparatus as set forth in claim 23 whereby said member is made of a non-ferrous metal.

26. The apparatus as set forth in claim 25 whereby said non-ferrous metal is copper.

27. The apparatus as set forth in claim 25 whereby said non-ferrous metal is a copper alloy.

28. The apparatus as set forth in claim 23 wherein said cutting edge is suspended above said protrusions via distance in the range of about 1 millimetre to 10 millimetres.

29. The apparatus as set forth in claim 23 wherein said protrusions are pyramid shaped.

30. The apparatus as set forth in claim 23 wherein said housing further comprises a layer of metal disposed between said protrusions and said cutting edge when said cutting edge tool is supported by said housing.

31. The apparatus as set forth in claim 30 wherein said layer of metal is made of a non-ferrous metal.

32. The apparatus as set forth in claim 31 wherein said non-ferrous metal is copper.

33. The apparatus as set forth in claim 31 wherein said non-ferrous metal is a copper alloy.
